(19) United States
(12) Patent Application Publication
(10) Pub. No.: US 2015/0158375 A1
(43) Pub. Date: Jun. 11, 2015

(54) COOLING UNIT IN ELECTRIC FOUR WHEEL DRIVE SYSTEM

(71) Applicant: Hyundai Motor Company, Seoul (KR)

(72) Inventor: Ji Yeol Jeong, Gwangmyeong (KR)

(21) Appl. No.: 14/340,105

(22) Filed: Jul. 24, 2014

(30) Foreign Application Priority Data
Dec. 5, 2013 (KR) 10-2013-0150695

(51) Int. Cl. B60K 11/04

(52) U.S. Cl. CPC B60K 11/04

(57) ABSTRACT

A cooling unit in an electric four wheel drive system is provided. In particular, the cooling unit in an electric four wheel drive system disclosed is configured and structured to cool a motor and an inverter in the electric four wheel drive system disposed on a rear axle side of a vehicle and may include a cooling circuit mounted on the rear axle of the vehicle that supplies coolant liquefied from gas to the motor and the inverter from a compressor and condenser disposed in the rear axle side of the vehicle.

### CROSS-REFERENCE TO RELATED APPLICATION

The present application claims priority of Korean Patent Application Number 10-2013-0150695 filed on Dec. 5, 2013, the entire contents of which application are incorporated herein for all purposes by this reference.

### BACKGROUND OF INVENTION

(a) Field of Invention

The present invention relates to an electric four wheel drive system. More particularly, the present invention relates to a cooling unit in an electric four wheel drive system for cooling heat generating units, such as a motor module which provides electromotive power to rear wheels of a front engine front wheel drive vehicle and an inverter.

(b) Description of Related Art

In general, the electric four wheel drive system (e-4WD) is system in which rear wheels of a Front engine Front wheel drive system is driven by a motor to obtain a 4WD functionality and an HEV function at the same time. More specifically, an electric four wheel drive system operates the motor with surplus power from an engine to provide four wheel drive functionality to a vehicle while allowing the engine to only power the front wheels. These systems have been implemented into vehicles for mass production by some of the world automotive manufactures.

These electric four wheel drive systems do not require an expensive and large capacity battery that are typically applied to a hybrid vehicle or a fuel cell vehicle. Instead, they obtain their required power from a large capacity generator for driving the motor. That is, vehicles which implement these types of electric four wheel drive systems have power from the engine and the transmission connected to the front wheels, and is provided with a generator for transformation of mechanical energy which is surplus power of the engine to electric energy.

In particular, the motor, the inverter, and a reduction gear are typically mounted to a rear wheel side of the vehicle for being driven by the electric energy provided from the generator, and an output from the motor and the reduction gear may be transmitted to the rear wheels through a drive shaft.

The electric four wheel drive system applicable to the Front engine Front wheel drive system provides a reduced weight characteristic owing to the removal of a propeller shaft therefrom enabling to improve fuel consumption and minimized loss in power during operation.

In order to properly cool these types of system, a cooling system must be applied to reduce the heat that is generated by particular components in the system. In particular, cooling water is typically circulated through the motor and the inverter to attempt to cool these components.

For an example, referring to FIG. 1, the cooling system has a cooling water reservoir 2, a water pump 3, and a radiator 4 mounted to an engine compartment in a front of the vehicle. In this case, as described before, the electric four wheel drive system including the motor 6 and the inverter 8 is mounted to a rear side of the vehicle. Accordingly, the cooling system circulates the cooling water from the cooling water reservoir 2 to the radiator 4, the motor 6 and the inverter 8 with the water pump 3 in order to cool the motor 6 and the inverter 8.

In this case, a circulating passage of the cooling water which circulates through the cooling water reservoir 2, the water pump 3, the radiator 4, the motor 6, and the inverter 8 is constructed of a cooling water pipeline 9 made of copper which is comparatively expensive.

Also, since the related art cooling system includes the cooling water reservoir 2, the water pump 3, and the radiator 4 arranged in the front side of the vehicle, a length of the cooling water pipeline 9 connecting those water cooling type cooling elements to the motor 6 and the inverter 8 in the rear side of the vehicle is extensive and expensive, and a connection structure of the cooling water pipeline 9 may become complicated.

That is, since the water cooling type cooling elements are disposed in an engine compartment of the vehicle and the motor 6 and the inverter 8 are provided in a trunk of the vehicle and a lower side of a vehicle body in the related art, the distance from the water cooling type cooling elements to the motor 6 and the inverter 9 is quite far apart. As such, more than 12 m of the cooling water pipeline 9 is required.

Moreover, since the layout of the conventional cooling systems is quite complicated, cost, volume and weight of the whole cooling system is likely to increase.

The above information disclosed in this Background section is only for enhancement of understanding of the background of the invention and therefore it may contain information that does not form the prior art that is already known in this country to a person of ordinary skill in the art.

### SUMMARY OF INVENTION

The present invention has been made in an effort to provide a cooling unit in an electric four wheel drive system which simplifies the entire system configuration, and increases performance of cooling heat generating units.

An object of the present invention is to provide a cooling unit in an electric four wheel drive system which can simplify entire system configuration, and can increase a performance of cooling heat generating units, such as a motor and an inverter.

In an exemplary embodiment of the present invention, a cooling unit, in an electric four wheel drive system for cooling a motor and an inverter in the electric four wheel drive system on a rear axle side of a front engine front wheel drive system vehicle, may include a cooling circuit mounted on a rear side of the vehicle for supplying coolant liquefied from gas to the motor and the inverter.

In some exemplary embodiments of the present invention, a cooling unit in accordance with an exemplary embodiment of the present invention is implemented, the cooling circuit may include a compressor for compressing gas state coolant, and a condenser for liquefying the coolant compressed at the compressor.

And, in a cooling unit in accordance with an exemplary embodiment of the present invention, the cooling circuit may further include an expansion valve for expanding the liquid coolant condensed at the condenser. As such, the cooling circuit may supply the liquid coolant subjected to adiabatic expansion by the expansion valve to the motor and the inverter.

As such, the motor and the inverter may include cooling passages for flow of the liquid coolant, respectively. In particular, the motor may have the cooling passage formed in a motor housing and the inverter may have the cooling passage formed in a case member.

The cooling circuit, in accordance with the exemplary embodiment of the present invention, may cool the motor and the inverter by heat exchange between the liquid coolant flowing through the cooling passage and surrounding air, and may supply gaseous coolant vaporized as the coolant passes through the motor and the inverter to the compressor.

The expansion valve, in some exemplary embodiments, may be connected to the motor and the inverter through a coolant introduction line, respectively, and the compressor may be connected to the motor and the inverter through a coolant flow out line.

Additionally, in another exemplary embodiment of the present invention, a cooling unit in an electric four wheel drive system for cooling heat generating units in the electric four wheel drive system disposed on a rear wheel side of a front engine vehicle, may include a cooling circuit of an air conditioner type mounted to a rear side of the vehicle for supplying coolant liquefied from gas to the heat generating units to cool the heat generating units.

Different from the related art in which the motor and the inverter are cooled with cooling water delivered from a front side (i.e., the radiator) to the rear side of the vehicle, the exemplary cooling unit can cool the motor and the inverter which are heat generating units in the electric four wheel drive system with the cooling circuit disposed at the rear axle side of the vehicle. As such, the entire length of the pipeline for cooling the motor and the inverter can be reduced to be shorter than 1 m, and a pipe connection structure can be simplified.

Moreover, in an exemplary embodiment of the present invention, since the motor and the inverter which are heat generating units in the electric four wheel drive system can be cooled with the cooling circuit provided to the rear wheel side of the vehicle, a layout of the cooling system is simplified, and a cost, volume and weight of the cooling system reduced.

Furthermore, different from the related art in which the motor and the inverter are cooled with water, since, in an exemplary embodiment of the present invention, the motor and the inverter are cooled with the cooling circuit of an air conditioner type using liquefied gas coolant, cooling performance and efficiency on the heat generating units in the electric four wheel drive system can be improved.

### BRIEF DESCRIPTION OF THE DRAWINGS

The attached drawings illustrate exemplary embodiments of the present invention, provided for describing the present invention in more detail, but not for limiting technical aspects of the present invention.

FIG. 1 illustrates a block diagram of a related art cooling structure in an electric four wheel drive system in a vehicle of a Front engine Front wheel drive system, schematically.

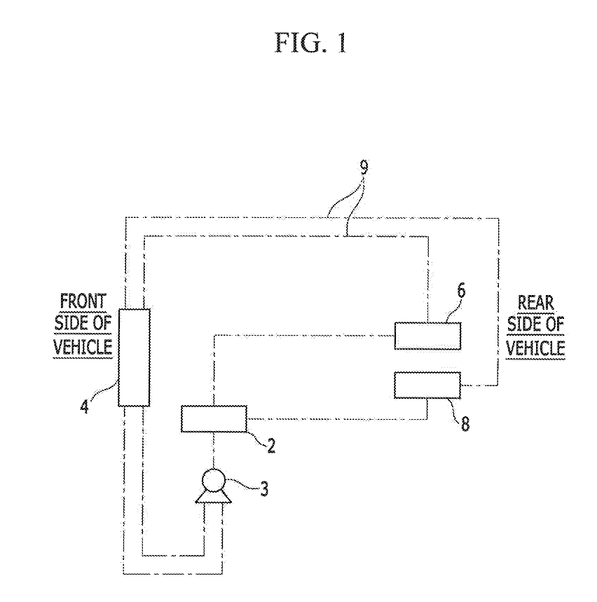

FIG. 2 illustrates a block diagram of a cooling unit in an electric four wheel drive system in a vehicle of a Front engine Front wheel drive system in accordance with an exemplary embodiment of the present invention, schematically.

FIGS. 3A and 3B illustrate schematic views of a cooling structure of a motor and an inverter applicable to a cooling unit in an electric four wheel drive system in accordance with an exemplary embodiment of the present invention, respectively.

FIG. 4 illustrates a block diagram of a cooling circuit applicable to a cooling unit in an electric four wheel drive system in accordance with an exemplary embodiment of the present invention, schematically.

### DETAILED DESCRIPTIONS

Hereinafter, the present invention will be described in more detail with reference to the accompanying drawings so that persons skilled in this field of art can embody, easily. As those skilled in the art would realize, the described embodiments may be modified in different ways, all without departing from the spirit or scope of the present invention.

In order to describe the present invention clearly, parts not related to description of the present invention are omitted, and, throughout the specification, the same reference numbers will be used throughout the drawings to refer to the same or like parts.

Since a thickness or a size of an element shown in a drawing can be shown at designer's discretion for convenience of description, the present invention is not limited by ones shown in the drawings, and a thickness may be enlarged to expressing many portions or regions clearly.

And, though terms including ordinal numbers, such as first or second, can be used for describing various elements, the elements are not confined by the terms, and are used only for making one element distinctive from other elements.

Throughout the specification, unless explicitly described to the contrary, the word “comprise” and variations such as “comprises” or “comprising”, will be understood to imply the inclusion of stated elements but not the exclusion of any other elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

And terms, such as “ . . . unit”, “ . . . means”, “ . . . portion”, or “ . . . member” described in the specification means a unit of an element which has at least one function or operation.

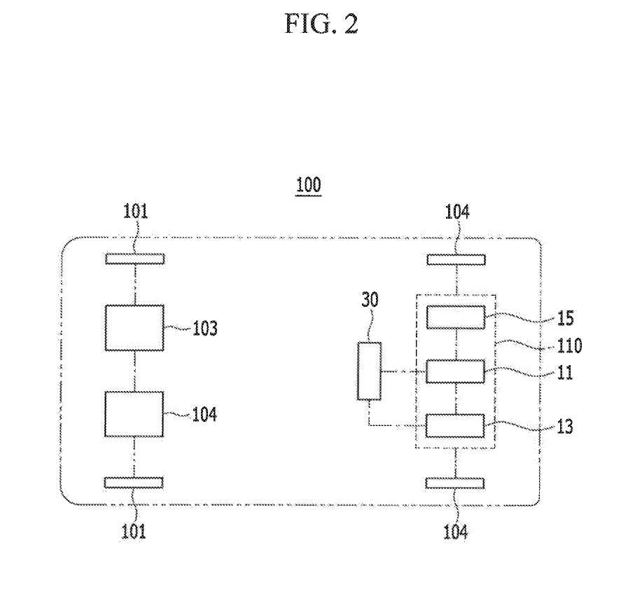

FIG. 2 illustrates a block diagram of a cooling unit in an electric four wheel drive system in a vehicle of a Front engine Front wheel drive system in accordance with an exemplary embodiment of the present invention, schematically. Referring to FIG. 2, the cooling unit according to an exemplary embodiment of the present invention may be applicable to a hybrid vehicle which uses a torque from an engine as main power and a torque from a motor 11 driven by electric energy as supplementary power.

For an example, an exemplary embodiment of the present invention may be applicable to an electric four wheel drive system 110 which drives the rear wheels 104 with the torque of the motor 11 provided to a rear wheel 104 side in a front engine front wheel drive system vehicle having the engine 102 and the transmission 103 provided to a front wheel 101 side.

Moreover, the electric four wheel drive system 110 applicable to an exemplary embodiment of the present invention may be an in-line system in which a left side and a right side rear wheels 104 are driven by one motor 11.

In this case, the front engine front wheel drive system vehicle having the electric four wheel drive system 110 applied thereto includes a generator (Not shown) provided to a front wheel 101 side for transformation of mechanical energy which is surplus energy of the engine 102 to electric energy.

In addition, besides the motor 11 described before, the electric four wheel drive system 110 has an inverter 13 for transformation of high voltage DC power generated by a battery or a generator to U, V, W three phase AC power and driving the motor 11 and a reduction gear 15 for reducing a speed of the torque of the motor 11, mounted to the rear axle 104 side of the vehicle.

Therefore, the electric four wheel drive system 110 can drive the rear wheels 104 with the torque from the motor 11 in the front engine front wheel drive system vehicle, and can secure runaway and hill climbing ability at a low speed section if slip takes place at the front wheels 101.

Since a configuration of the electric four wheel drive system 110 is the in-line type electric four wheel drive system which is known widely in this field of art, more detailed description of the configuration will be omitted from this specification.

In the meantime, the motor 11 and the inverter 13 are heat generating units which generate heat in the electric four wheel drive system 110. The heat generating units of the motor 11 and the inverter 13 may be cooled by a cooling medium circulated by a cooling unit 100 in accordance with an exemplary embodiment of the present invention.

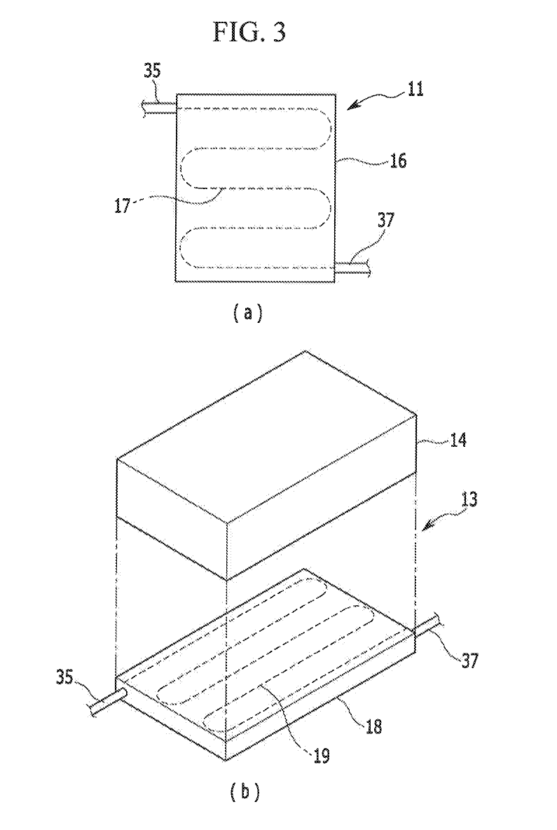

Accordingly, as shown in FIG. 3A, the motor 11 has a first cooling passage 17 formed in a motor housing 16 for circulating the cooling medium, and, as shown in FIG. 3B, the inverter 13 has a second cooling passage 19 formed in a case member 18 which supports a switching device 14, such as a power module, for circulating the cooling medium.

The cooling unit 100 in the electric four wheel drive system 110 in accordance with an exemplary embodiment of the present invention has a structure which can simplify a configuration of the cooling system which cools the heat generating units, including the motor 11 and the inverter 13, and can improve a performance of cooling the heat generating units.

For this, the cooling unit 100 in the electric four wheel drive system 110 in accordance with an exemplary embodiment of the present invention includes a cooling circuit 30 which uses coolant liquefied from gas as the cooling medium.

In an exemplary embodiment of the present invention, the cooling circuit 30 is a cooling circuit of an air conditioner type mounted on the rear side of the vehicle. That is, the cooling circuit 30 may be mounted in the trunk and on a lower side of the vehicle body on the rear wheel side of the vehicle, arranged to one side of the motor 11 and the inverter 13 of the electric four wheel drive system 110.

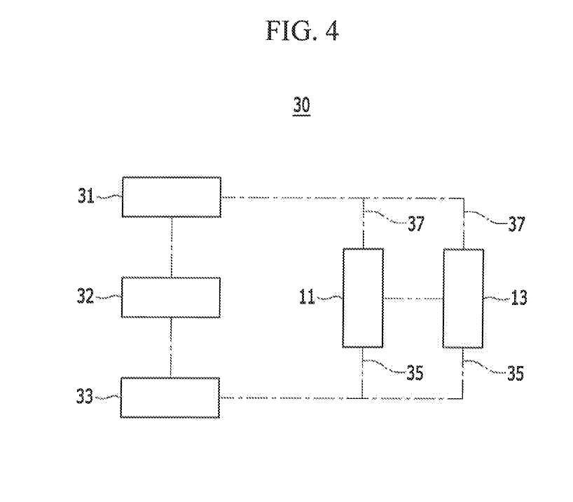

FIG. 4 illustrates a block diagram of a cooling circuit applicable to a cooling unit in an electric four wheel drive system in accordance with an exemplary embodiment of the present invention, schematically. Referring to FIGS. 2 and 4, the cooling circuit 30 is a refrigerating cycle device for cooling heat generated by the motor 11 and the inverter 13 by using latent heat of the coolant, and includes a compressor 31, a condenser 32, and an expansion valve 33. In this case, the coolant may include a variety of materials, such as R-134a, R-134yf, and R-744, known widely in this field of art.

The compressor 31 draws gaseous coolant and compresses to high temperature, and high pressure, and the condenser 32 receives the coolant compressed thus from the compressor 31, and condenses the coolant into a liquid state by making heat exchange with air. And, the expansion valve 33 subjects the liquid state coolant supplied thereto from the condenser 32 to adiabatic expansion to a low temperature and low pressure state.

Since the compressor 31, the condenser 32 and the expansion valve 33 in the cooling circuit 30 are elements of an air conditioning system known widely in this field of art, more detailed description of the configuration will be omitted from this specification.

In this case, the cooling circuit 30 in accordance with an exemplary embodiment of the present invention may supply the liquid coolant adiabatically expanded into the low temperature and the low pressure to the first cooling passage 17 in the motor housing 16 as shown in FIG. 3A, and may supply to the second cooling passage 19 in the case member 18 of the inverter 13 as shown in FIG. 3B.

Accordingly, the expansion valve 33 may be connected to the first cooling passage 17 in the motor housing 16 and the second cooling passage 19 in the case member 18 through a coolant introduction line 35. That is, the coolant introduction line 35 is connected to inlet sides of the first and second cooling passages 17 and 19.

Therefore, the cooling circuit 30 in accordance with an exemplary embodiment of the present invention may cool the motor 11 and the inverter 13 by heat exchange of the liquid coolant flowing through the first and second cooling passages 17 and 19 with surrounding air.

In this case, the liquid coolant flowing along the first and the second cooling passages 17 and 19 may cool the motor 11 and the inverter 13 by heat exchange with the heat generated by the motor 11 and the inverter 13, may vaporize into a gas state by the heat, and may be supplied to the compressor 31 described before. That is, the motor 11 and the inverter 13 serve as an evaporator in a refrigerating cycle for vaporizing the liquid coolant into the gas state.

For this, an outlet of the first cooling passage 17, and an outlet of the second cooling passage 19 may be connected to the compressor 31 through coolant flow out lines 37.

The operation of the foregoing cooling unit in the electric four wheel drive system in accordance with an exemplary embodiment of the present invention will be described with reference to the drawings, in detail.

First of all, in an exemplary embodiment of the present invention, the motor 11 and the inverter 13 generate heat when the electric four wheel drive system 110 is operated,

In order to cool the heat generated by the motor 11 and the inverter 13 which are heat generating units in the electric four wheel drive system 110, in an exemplary embodiment of the present invention, the compressor 31 in the cooling circuit 30 draws in gas state coolant, compresses the same to a high temperature and high pressure, and supplies the same to the condenser 32.

Then, the condenser 32 receives the gaseous coolant compressed thus from the compressor 31, condenses the coolant into a liquid state by heat exchange of the coolant with air, and supplies the liquid coolant condensed thus to the expansion valve 33. Then, the expansion valve 33 subjects the liquid state coolant supplied from the condenser 32 to adiabatic expansion into a low temperature and low pressure state.

Then, in an exemplary embodiment of the present invention, the liquid coolant subjected to adiabatic expansion into the low temperature and low pressure state at the expansion valve 33 is supplied to the first cooling passage 17 in the motor housing 16 of the motor 11 and the second cooling passage 19 of the case member 18 of the inverter 13 through the coolant introduction line 35.

According to this, the low temperature and low pressure liquid coolant flows along the first cooling passage 17 in the motor housing 16 and the second cooling passage 19 of the case member 18 to cool the motor 11 and the inverter 13 by heat exchange with surrounding air.

Then, the liquid coolant flowing along the first and second cooling passages 17 and 19 cools the motor 11 and the inverter 13 by heat exchange with the heat generated by the motor 11 and the inverter 13, is vaporized into a gas state by the heat and is supplied to the compressor 31 through the coolant flow out line 37.

Accordingly, the cooling unit 100 in an electric four wheel drive system 110 in accordance with an exemplary embodiment of the present invention can cool the motor 11 and the inverter 13 which are heat generating units in the electric four wheel drive system 110 on a rear wheel side of the vehicle with a refrigerating cycle of the foregoing cooling circuit 30.

Thus, different from the related art in which the motor and the inverter are cooled with cooling water over a front side and a rear side of the vehicle, the cooling unit 100 in an electric four wheel drive system 110 in accordance with an exemplary embodiment of the present invention can cool the motor 11 and the inverter 13 which are heat generating units in the electric four wheel drive system 110 with the cooling circuit 30 provided to the rear wheel 104 side of the vehicle.

As such, in an exemplary embodiment of the present invention, since the cooling circuit 30 for cooling the motor 11 and the inverter 13 is provided to the rear wheel side, different from the related art, the length of the pipeline for cooling the motor 11 and the inverter 13 can be reduced to be shorter than 1m, and a pipe connection structure can be simplified.

Moreover, in an exemplary embodiment of the present invention, since the motor 11 and the inverter 13 which are heat generating units in the electric four wheel drive system 110 can be cooled with the cooling circuit 30 provided to the rear wheel 104 side of the vehicle, the layout of the cooling system is simplified, and the cost, volume and weight of the cooling system can be reduced.

Furthermore, different from the related art in which the motor and the inverter are cooled with water, since, in an exemplary embodiment of the present invention, the motor 11 and the inverter 13 are cooled with the cooling circuit 30 of an air conditioner type using coolant, cooling performance and efficiency on the heat generating units in the electric four wheel drive system 110 can be improved.

While this invention has been described in connection with what is presently considered to be practical exemplary embodiments, it is to be understood that technical aspects of the present invention are not limited to the exemplary embodiments suggested in the specification, but, though a person of an ordinary skill in this field of art who understands the technical aspects of the present invention can suggest another exemplary embodiment by modifications, changes, removal, and addition of constituent elements within a range of technical aspects the same with the present invention, it may also be within a range of right of the present invention.

<Description of symbols>

| | | | |
|---|---|---|---|
| 11 | motor | 13 | inverter |
| 14 | switching device | 15 | reduction gear |
| 16 | motor housing | 17 | first cooling passage |
| 18 | case number | 19 | second cooling passage |
| 30 | cooling circuit | 31 | compressor |
| 32 | condenser | 33 | expansion valve |
| 35 | coolant introduction line | 37 | coolant flow out line |
| 101 | front wheel | 102 | engine |
| 103 | transmission | 104 | rear wheel |
| 110 | electric four wheel drive system | | |

What is claimed is:

1. A cooling unit in an electric four wheel drive system for cooling a motor and an inverter in the electric four wheel drive system on a rear wheel side of a front engine front wheel drive system vehicle, comprising:
a cooling circuit mounted on a rear side of the vehicle that supplies coolant liquefied from gas via a condenser to the motor and the inverter to cool the motor and the invertor.

2. The cooling unit of claim 1, wherein the cooling circuit includes;
a compressor that compresses gas state coolant, and
a condenser that liquefies the coolant compressed at the compressor.

3. The cooling unit of claim 2, wherein the cooling circuit further includes an expansion valve that expands the liquid coolant condensed at the condenser.

4. The cooling unit of claim 3, wherein the cooling circuit
supplies the liquefied coolant subjected to adiabatic expansion by the expansion valve to the motor and the inverter.

5. The cooling unit of claim 1, wherein the motor and the inverter include a plurality of cooling passages for flow of the liquefied coolant, respectively.

6. The cooling unit of claim 5, wherein the motor has the cooling passage formed in a motor housing and the inverter has the cooling passage formed in a case member.

7. The cooling unit of claim 1, wherein the cooling circuit
cools the motor and the inverter by exchanging heat between the liquid coolant flowing through the cooling passage and surrounding air, and
supplies gaseous coolant vaporized as the coolant passes through the motor and the inverter to the compressor.

8. The cooling unit of claim 2, wherein the expansion valve is connected to the motor and the inverter through a coolant introduction line, respectively, and
the compressor is connected to the motor and the inverter through a coolant flow out line.

9. A cooling unit in an electric four wheel drive system for cooling heat generating units in the electric four wheel drive system on a rear axle side of a front engine front wheel drive system vehicle, comprising:
a cooling circuit of an air conditioner type mounted to a rear side of the vehicle and configured to supply coolant liquefied from gas to one or more heat generating units to cool the one or more heat generating units.
